(19) United States
(12) Patent Application Publication
(10) Pub. No.: US 2024/0271643 A1
(43) Pub. Date: Aug. 15, 2024

(54) INNOVATIVE CONTROL AND SAFETY SYSTEM FOR CONVEYING CIRCUITS OF PRESSURIZED FLUIDS

(71) Applicant: STI S.R.L, Levate (BG) (IT)

(72) Inventors: Flavio Tondolo, Levate (BG) (IT); Nicola Zenoni, Levate (BG) (IT)

(73) Assignee: STI S.R.L, Levate (BG) (IT)

(21) Appl. No.: 18/569,355

(22) PCT Filed: Jun. 15, 2022
(86) PCT No.: PCT/IB2022/055532

§ 371 Date: Dec. 12, 2023

(30) Foreign Application Priority Data
Jun. 18, 2021 (IT) 102021000015839

(51) Int. Cl. F15B 19/00; F15B 20/00

(52) U.S. Cl. CPC F15B 19/005; F15B 20/005; F15B 2211/50554; F15B 2211/5151; F15B 2211/8855

(57) ABSTRACT

A control and safety system suitable for conveying circuits of pressurized fluids equipped with at least one process valve, the system comprising:—a pressure reducer,—a pilot element,—a control valve,—a selector valve,—a flow amplifier valve, e—a single-acting actuator, wherein the system is provided with a single circuit in which:—a supply line of a working fluid directly connects the pressure reducer, to the control valve and to the flow amplifier valve,—a signal fluid line, directly connected: to the piloting element and to a manual pilot control element, or to the pilot element and to the pressure reducer and to a non-return valve.

### BACKGROUND OF THE INVENTION

### 1. Field of the Invention

The present invention relates to an innovative control and safety system suitable for conveying circuits of pressurized fluids.

In fact, during the operation of these circuits, one of the greatest risks occurs when at least one part of the process circuit may be in overpressure conditions, with the consequent structural failure of a part of this circuit and the leakage of the process fluid. For this reason, the primary aim of the present invention is to verify the circuit and the components used for the implementation of countermeasures designed to avoid the occurrence of such problems.

### 2. Brief Description of the Prior Art

Over time, various safety systems have been developed to prevent the leakage of a process fluid from a pressurized circuit, when an abnormal overpressure occurs that jeopardizes the integrity of the circuit itself.

A first system provides for the opening of an alternative discharge for the process fluid if the pressure is beyond the safety limits. In such circumstances the fluid is discharged and removed from the circuit line, so avoiding the aforementioned problems but adding complications related to how to treat the discharge process flow.

According to other known systems and methods, it is instead preferred to block the fluid in suitably designed portions of the system, that is, capable of containing high pressures and thus avoiding damage to the other parts of the installation. In these systems, process valves are therefore used which act as a barrier between the areas designed for high pressure and those not suitable for containing high pressures. These valves and the accompanying instrumentation used are called HIPPS, an acronym for “High Integrity Pressure Protection System”.

Due to the safety function they must perform, such process valves are kept constantly open in order to allow the continuous flushing of the process fluid and are closed if overpressure problems arise, thus carrying out the emergency step, or by performing the safety function. For this reason, amplification devices necessary to achieve the safety function in adequate times are often used, usually in the order of a few seconds. During the useful life of the system, however, it may be useful to ascertain the correct operation of these process valves by carrying out a partial closing operation of the valve itself in anticipation of a possible future use. This step, typically called “partial stroke test” (hereinafter also “partial stroke maneuver”), is clearly more efficient if it verifies the correct functioning of the complete accessories supplied with the valve in question, without excluding any part of the useful circuit logic to the handling of the valve. It is also evident how minimizing the execution time of this maneuver can lead to both economic and technical advantages, as the process would be altered for a shorter period of time. Furthermore, performing the test with a speed comparable to the hypothetical emergency step is more probable as it approaches the real emergency conditions.

In order to better understand how, according to the known art, the “partial stroke test” is carried out and what are the current limits that the invention aims to overcome, an accurate explanation is necessary and for this reason reference is made to the attached FIG. 1 (which represents hence the today state of the art.

As shown in this figure, a system with a single-acting on-off actuator, configured for partial stroke maneuvers, typically consists of: a pressure reducer 1, a solenoid valve 2, a three-way valve with pneumatic/hydraulic pilot 4, a three-way valve with manual pilot 7, a three-way valve with mechanical pilot 9, three control valves 3, 6, 8, two quick discharge valves 5, 10, and a single-acting on-off actuator 11.

This system can be divided into two circuits: the first circuit A, useful for the normal operation of the actuator, and the second circuit B, necessary to perform the partial stroke maneuver (partial stroke test).

Considering circuit A, in the example shown in FIG. 1, the chamber 12 of the actuator 11 is the chamber to be pressurized in order to open the process valve (not shown in FIG. 1) on which the single-acting actuator 11 is mounted. Under normal operating conditions of the valve, the latter must be kept totally open, and therefore the chamber 12 of the single-acting actuator 11 must be kept under pressure. For this reason, the chamber 12 is connected to the working fluid supply line according to circuit A. The working fluid supply line (indicated in FIG. 1 as “FLUID SUPPLY”) is connected to the solenoid valve 2 and to the control valve 3 through a pressure reducer 1. The solenoid valve 2 controls the pilot of the three-way pneumatic/hydraulic pilot valve 4 while the control valve 3 regulates its supply. The output of the three-way pneumatic/hydraulic pilot valve 4 is connected to the quick discharge valve 5. The latter acts in two ways: it can either put the working fluid supply line in communication with the chamber 12 of the single-acting actuator 11 (and in such case reference is made to an actuator load action), or it can put the chamber 12 of the single-acting actuator 11 in communication with the control valve 6 (in this second case reference is made to a discharge action of the actuator). The control valve 6 communicates with the external environment or to a dedicated conveying circuit, so allowing the fluid to be discharged. The state of the quick discharge valve 5, and therefore the way it operates, is defined by the pressures established upstream of the quick discharge valve 5 itself.

When acting on the solenoid valve 2, on the control valve 3 (for the regulation of the flow rate during the loading phase of the chamber 12 of the single-acting actuator 11) and on the control valve 6 (for the regulation of the flow rate during the discharge phase of the chamber 12 of the single-acting actuator 11), such circuit is therefore able to manage the movement of the single-acting actuator 11, so allowing the closing or opening of the process valve on which it is mounted. In normal operating conditions, the valve is completely open and therefore the solenoid valve 2 is kept energized (with a SIGNAL electrical signal) in order to guarantee the communication between the supply line of the working fluid and the chamber 12 of the single-acting actuator 11. In emergency conditions, when it is necessary to quickly close the process valve, the solenoid valve 2 will be de-energized. This will change the state of the quick discharge valve 5 and consequently the chamber 12 of the single-effect actuator 11 will be put in communication with the control valve 6, which releases the pressure into the atmosphere.

Considering now the Circuit B, in addition to what has been described before, such circuit has additional components, useful for carrying out the partial stroke maneuver. As shown in FIG. 1, the chamber 12 is in fact connected to the upper chamber 13 by means of several components placed in series. More precisely and starting from chamber 12, such components are the following: control valve 8, three-way manual pilot valve 7, three-way mechanical pilot valve 9 and quick discharge valve 10. The latter can put in communication the upper chamber 13 of the single-acting actuator 11 either with the three-way mechanical pilot valve 9, or the upper chamber 13 of the single-acting actuator 11 with the external environment or to the dedicated conveying circuit. The mechanical pilot of the three-way valve 9 is also connected to the kinematic mechanism 11′ of the single-acting actuator 11, thus representing the degree of opening of the process valve on which the single-acting actuator 11 is mounted.

The utility of this circuit is to allow communication between the chamber 12 and the upper chamber 13 of the single-acting actuator 11 in the event that the valve is in a predetermined stroke range and in case of a request by an operator. In particular, if the valve is between the total opening and a determined intermediate position, the three-way mechanical pilot valve 9 is de-energized. The intermediate position is defined by the position of the kinematic mechanism 11′ of the actuator 11. As in normal operating conditions the valve is completely open, the three-way mechanical pilot valve 9 is therefore de energized. In these conditions, the only discriminating factor in order to create the by-pass between the chambers 12 and 13 and to carry out the partial stroke test is the status of the three-way valve manual pilot valve 7. If necessary, an operator can therefore energize this three-way valve 7, starting the partial stroke maneuver. Indeed: by energizing the three-way manual pilot valve 7, the chambers 12 and 13 of the actuator 11 are put into communication, with a consequent increase in pressure in the upper chamber 13 and the beginning of the valve closing phase. Once the predetermined stroke percentage has been reached, the three-way mechanical pilot valve 9 is energized as it is piloted by the mechanical connection set on the kinematic mechanism 11′ of the actuator 11. In these conditions, the quick discharge valve 10 is de-energized, so placing in direct connection the upper chamber 13 with the external environment or the dedicated conveying circuit. The consequent decrease in pressure of the upper chamber 13 therefore involves a trend by the single-acting actuator 11 to open the process valve again, due also to the thrust given by an elastic means, typically a spring 14. In these circumstances, the mechanical connection set on the kinematic mechanism 11′ of the actuator 11 will cause a further change of the state of the three-way mechanical pilot valve 9, so returning it to the de-energized state. The final effect is therefore the modulation of the pressure in the chambers 12 and 13 by means of the three-way mechanical pilot valve 9, with consequent management of the process valve in the position associated with the intermediate position defined by the kinematic mechanism 11′ of the actuator 11. Such position is that relating to the partial stroke maneuver; by subsequently de-energizing the three-way manual pilot valve 7, the supply to the upper chamber 13 is totally excluded, thus exiting from the partial stroke maneuver. Under normal operating conditions, the circuit A will then supply the chamber 12, so returning the valve to its fully open state.

From the example described, according to the known art, it follows that: the emergency closing of the process valve (therefore the fulfillment of its safety function) is carried out by an actuator and by the respective control circuit (circuit A, in the example shown), however, such circuit is not involved during the partial stroke test as this function is performed by a dedicated test circuit (circuit B), capable of only verifying the correct function of the actuator-valve system only.

In this way the diagnostic coverage of the test is negligible as it excludes the control circuit of the actuator useful for carrying out the emergency maneuver.

The Applicant has already devised a new single-circuit circuit system capable of carrying out both the partial stroke phase and the emergency maneuver. In particular, as described in the European patent application EP 3824192 A1 which is incorporated by reference, the Applicant has devised a first circuit diagram of a control and safety system for a conveying circuit of pressurized fluids, equipped with an electric control and a second circuit diagram of a control and safety system for a conveying circuit of pressurized fluids, without an electric control.

While the first circuit diagram responded with satisfaction to the expectations set by the Applicant, the second circuit diagram (without an electric control) was found to be unsuitable for carrying out both the “partial stroke” and the emergency maneuvers and, in particular, its result is not suitable for carrying out the emergency maneuver. On the other hand, the circuit diagram without an electric control is of particular interest if it is not possible to activate the partial stroke test and/or the emergency maneuver by means of an electric signal.

There is therefore a need to define a new control and safety system suitable for conveying circuits of pressurized fluids which overcomes the drawbacks described.

### SUMMARY OF THE INVENTION

The main purpose of the present invention is achieved by the definition of a new circuit system capable of carrying out both the partial stroke phase and the emergency maneuver, in the absence of any electrical control. In this way, the present invention overcomes the limits of the known art, as during the partial stroke phase, it allows to check the entire actuator-circuit-process valve system, so as to guarantee a total diagnostic coverage that involves all the useful components. In order to perform the safety function, in emergency conditions.

Furthermore, the control circuit is designed in such a way as to perform the partial stroke phase in shorter times than that used by the systems according to the known art, at the same time with times similar to the actual phase, at the same time exploiting the components already used for the emergency operation of the actuator and without implementing dedicated circuits.

Finally, the new circuit system overcomes the limits of the prior art in cases where it is not possible to activate the partial stroke test and/or the emergency maneuver by means of an electrical signal.

These and other aims and advantages are achieved, according to the invention, by a control and safety system suitable for conveying circuits of pressurized fluids having the characteristics set out in the appended independent claim.

Further preferred and/or particularly advantageous in embodiments of the invention are described according to the characteristics set out in the attached dependent claims.

### BRIEF DESCRIPTION OF THE DRAWINGS

The invention will now be described with reference to the attached drawings, which illustrate a non-limiting example of embodiment, in which:

FIG. 1 is a circuit diagram of a control and safety system for a conveying circuit of pressurized fluids, according to the known art,

FIG. 2 is a circuit diagram, with a single circuit, of a control and safety system for a conveying circuit of pressurized fluids, according to the known art,

FIG. 3 is a circuit diagram, with a single circuit, of a control and safety system for a conveying circuit of pressurized fluids, without an electric control, according to an embodiment of the present invention, and

FIG. 4 is a single circuit diagram of a control and safety system for a conveying circuit of pressurized fluids, without an electric control, according to an alternative embodiment of the present invention. Detailed description FIG. 2 shows a single-circuit circuit diagram of a control and safety system for a conveying circuit of pressurized fluids, as described in the European patent application EP 3824192 A1 of the same Applicant. By specifying that the diagram described below is evidently not a part of the present invention, it is preferred to illustrate it also in this patent application as an aid for the description of the diagrams of the present invention. Referring now to FIG. 2, the control and safety system for a conveying circuit of pressurized fluids is used to perform the partial stroke phase on single-acting on-off actuators. This system 100 includes: a pressure reducer 16, a control solenoid valve 17, a secondary solenoid valve 18, a pressure check switch 19, a selector valve 20, a flow amplifier valve 21, and a single acting actuator 22.

### DETAILED DESCRIPTION OF THE INVENTION

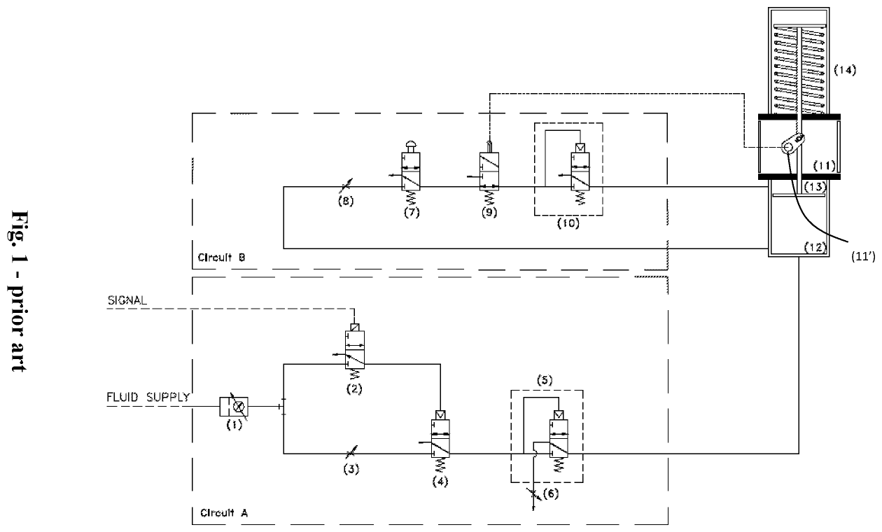

The system 100 by means of the circuit which will now be described is suitable both for carrying out both the partial stroke phase and for moving the single-acting actuator 22 in normal operating conditions and in emergency situations (rapid closing of the process valve). This circuit therefore groups together both the functions performed by circuit A and circuit B in FIG. 1, by using the same circuit members to carry out both the partial stroke phase and the emergency maneuver, with overlapping response characteristics. During the partial stroke phase, therefore, the entire control circuit is involved, so ensuring a complete diagnostic coverage of the actuator-circuit-valve system.

The working fluid line is directly connected to the flow amplifier valve 21, to the control solenoid valve 17 and to the pressure reducer 16. The secondary solenoid valve 18 is connected downstream of the latter one. The control solenoid valve 17 and the secondary solenoid valve 18 are both connected to the selector valve 20, which manages the delivery of the working fluid to the pilot of the flow amplifier valve 21. The pressure switch reads the pressure downstream of the secondary solenoid valve 18 and upstream of the selector valve 20. The flow amplifier valve 21 is directly connected to the single-acting actuator 22 and has the function of loading or unloading the actuator 22 on the basis of the pressure signal that reaches the pilot.

Let now consider both solenoid valves 17 and 18 in their de-energized state. If only the control solenoid valve 17 is energized, by closing a general electric switch 17′, the supply fluid will drive the flow amplifying valve 21, by passing through the selector valve 20. The effect of this is the amplified supply of the chamber 23 of the single effect actuator 22, allowed by the direct connection of the flow amplifier valve 21 with the line of the working fluid. Under these conditions, the valve operates normally, with the chamber 23 pressurized and the valve totally open. Therefore, by acting on the secondary solenoid valve 18 it is possible to carry out the partial stroke phase, in particular: by energizing the secondary solenoid valve 18, by closing a secondary switch 18′, the supply fluid reaches the selector valve 20 with a pressure equal to the value set by the pressure reducer 16. The pressure check switch 19 therefore reads the pressure increase along the line and modifies the state of the control solenoid valve 17, which shuts off the supply to the selector valve 20 and begins to discharge the residual fluid in the line communicating with such valve 20. The simultaneous effect of pressurizing the line downstream of the secondary solenoid valve 18 and discharging the line downstream of the control solenoid valve 17 results in a reduction of the pilot pressure of the flow amplifier valve 21 (and, consequently, in an amplified discharge of the chamber 23 of the single acting actuator 22). This behavior continues until a certain pressure value is reached in the chamber 23 of the single-acting actuator 22, as a function of the pressure established at the pilot of the flow amplifier valve 21, this pressure value being equal to the pressure value set at the pressure reducer 16. This means that for different setting values of the pressure reducer 16 it is possible to define different pressures in the chamber 23 of the single-acting actuator 22, so therefore defining a different position of the same actuator 22 and a different degree of opening of the process valve on which the actuator itself is mounted. The partial stroke value is therefore imposed by the setting on the pressure reducer 16; by subsequently de-energizing the secondary solenoid valve 18, it closes the supply to the selector valve 20 and discharges the residual fluid in the line communicating with such valve 20. The pressure drop along such line therefore involves the change of state of the solenoid valve control 17 by means of the impulse given by the pressure switch 19. The supply fluid therefore reaches the selector valve 20 exclusively from the line relating to the control solenoid valve 17, so allowing it to pass towards the pilot of the flow amplifier valve 21. The effect of this is the amplified supply of the chamber 23 of the single-acting actuator 22 through the flow amplifier valve 21, hence the complete opening of the valve.

Should one want to switch from a normal or partial stroke to an emergency operating situation, it would be necessary to act on the main electric switch. By opening the circuit, by operating the switch, both the secondary solenoid valve 18 and the control solenoid valve 17 are de-energized. This implies that the pilot of the flow amplifier valve 21 is communicating with the atmosphere. Therefore, as the chamber 23 of the single-acting actuator 22 is now also communicating with the atmosphere, the action of the spring prevails and causes the valve to close.

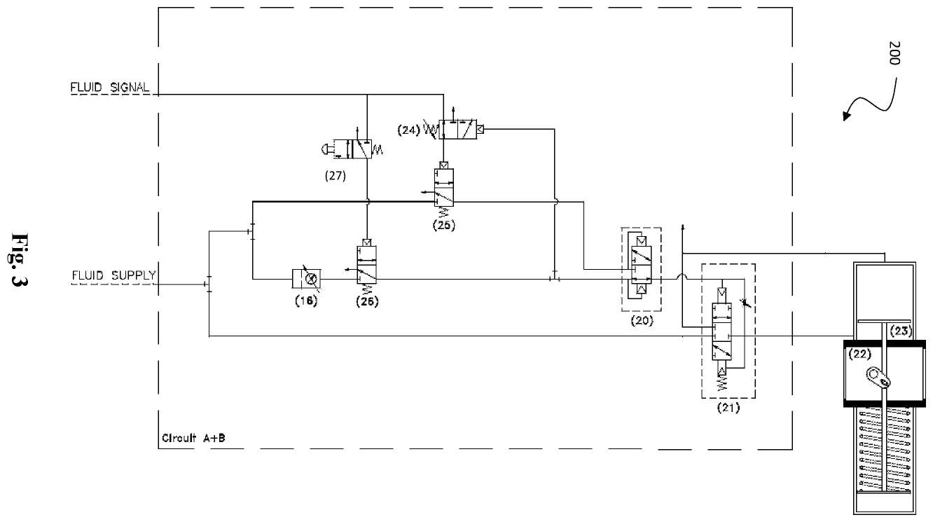

According to the present invention and with reference to FIG. 3, an embodiment of the control and safety system for a conveying circuit of pressurized fluids, with a single circuit and without an electric control, is now described.

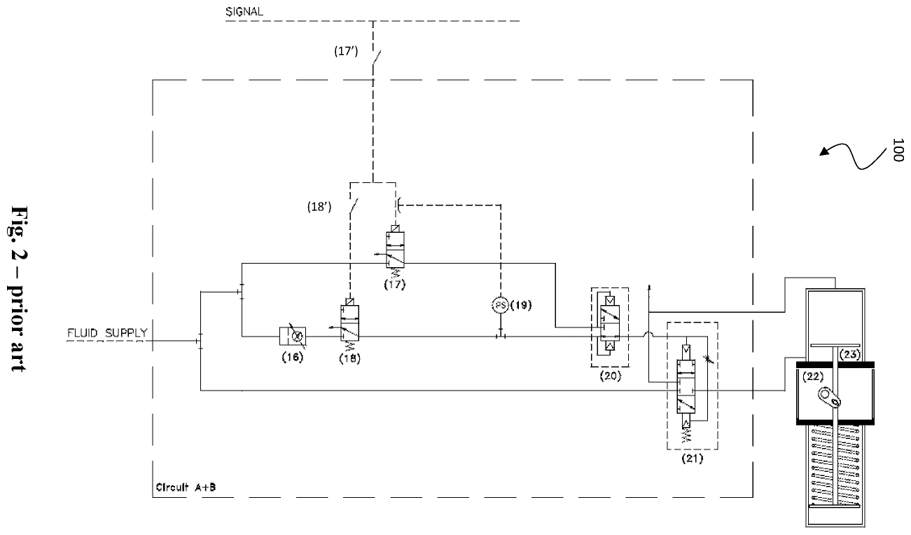

This system 200 is similar to the system described previously in FIG. 2, with the difference that in this latter configuration there is no electrically driven component. This alternative may be of particular interest if it is not possible to activate the partial stroke test and/or the emergency maneuver through an electrical i? signal. The system 200 includes: a pressure reducer 16, a three-way pilot valve 24, a three-way control valve 25, a secondary three-way control valve 26, a secondary three-way manual pilot valve 27, a selector valve 20, a flow amplifier valve 21, and a single acting actuator 22.

In particular, with respect to the system 100 of FIG. 2, in the system 200: the control solenoid valve 17 is replaced by the three-way control valve 25, the secondary solenoid valve 18 is replaced by the secondary three-way control valve 26, the secondary electric switch 18′ is replaced by the three-way manual pilot secondary valve 27 the pressure switch 19 is replaced by the three-way pilot valve 24.

The working fluid line is directly connected to the pressure reducer 16, to the flow amplifier valve 21 and to the three-way control valve 25. The secondary three-way control valve 26 is connected downstream of the pressure reducer 16. The line of the signal fluid is directly connected to the three-way manual pilot valve 27 and to the three-way pilot valve 24. The three-way control valve 25 is connected downstream of the three-way pilot valve 24. Both the secondary three-way control valve 26 and the three-way control valve 25 are connected to the selector valve 20, which manages the delivery of the working fluid to the pilot of the flow amplifier valve 21. The three-way pilot valve 24 is also connected downstream of the secondary three-way manual pilot valve 27 and upstream of the selector valve 20. The flow amplifier valve 21 is directly connected to the single-acting actuator 22 and has the function of loading or unloading the actuator 22 on the basis of the pressure signal that reaches the pilot.

The operation of the system 200 is described below. Let us consider the three-way manual pilot secondary valve 27 in its de-energized state. In these conditions the three-way pilot valve 24 is de-energized and therefore it allows the passage of the working fluid towards the pilot of the three-way control valve 25. The supply fluid will drive the flow amplifier valve 21, by passing through the three-way control valve 25 and the selector valve 20. The effect of this is the amplified supply of the chamber 23 of the single-acting actuator 22, allowed by the direct connection of the flow amplifier valve 21 with the line of the working fluid. Under these conditions, the valve operates normally, with the chamber 23 pressurized and the valve totally open. This condition is similar to the operation described for the circuit of FIG. 2, in which only the control solenoid valve 17 is energized.

On the other hand, by acting on the three-way manual pilot secondary valve 27 it is possible to carry out the partial stroke phase. In particular: by operating the three-way manual pilot secondary valve 27, the supply fluid will drive the three-way control valve 26, then the three-way pilot valve 24, which discharges the residual fluid to the pilot of the three-way control valve 25. The three-way control valve 25 is therefore de-energized, thus discharging the residual fluid between the three-way control valve 25 and the pilot of the selector valve 20. Similarly to what was previously described for the system 100 of FIG. 2, the simultaneous effect of the secondary three-way manual pilot valve 27 and of the three-way control valve 25 results in an amplified discharge of the chamber 23 of the single-acting actuator 22. In particular, for different setting values of the pressure reducer 16 it is possible to define different pressures in the chamber 23 of the single-acting actuator 22, therefore a different position of the same actuator 22 and a different degree of opening of the valve on which the single-acting actuator 22 is mounted. The partial stroke value, as well as for the actuation method of FIG. 2, is therefore imposed by the setting on the reducer 16; by subsequently deactivating the three-way manual pilot secondary valve 27, it closes the supply to the selector valve 20 and begins to discharge the residual fluid in the line communicating with the same selector valve 20. The three-way pilot valve 24 changes its state and again allows the working fluid to flow towards the pilot of the three-way control valve 25. The supply fluid therefore reaches the selector valve 20 exclusively from the line relating to the three-way control valve 25, so allowing it to pass through towards the pilot of the flow amplifier valve 21. The effect of this is the amplified supply of the chamber 23 of the single-acting actuator 22 through the flow amplifier valve 21, hence the complete opening of the valve.

Should one want to switch from a normal or partial stroke to an emergency operating situation, it is necessary to discharge the signal line, for example through a solenoid valve (or similar accessories) placed on the line, upstream of the reference system. In this way, independently of the check made on the three-way manual pilot valve 27, the three-way control valve 26 is de energized. Consequently, the three-way pilot valve 24 and the three-way control valve 25 are de-energized. This implies that the pilot of the flow amplifier valve 21 is communicating with the atmosphere. Therefore, as the chamber 23 of the single-acting actuator 22 is now also communicating with the atmosphere, the action of the spring prevails and causes the valve to close.

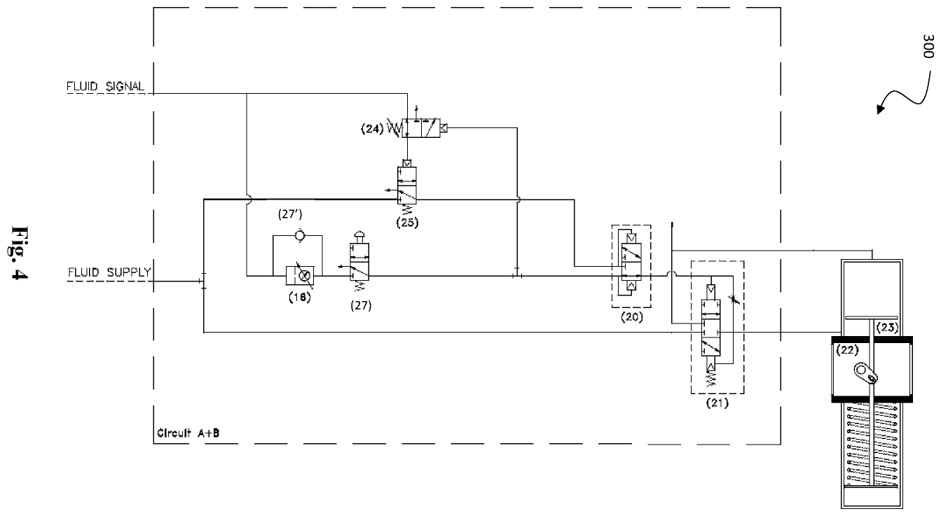

With reference to FIG. 4, a further alternative embodiment of the control and safety system for a conveying circuit of pressurized fluids, according to the present invention, is now described.

Also this system 300, as well as the system 200, is similar to the system 100 previously described in FIG. 2, with the difference that in the latter configuration there is no electrically driven component. This alternative may be of particular interest if it is not possible to activate the partial stroke test and/or the emergency maneuver through an electrical signal. The system 300 includes: a pressure reducer 16, a three-way pilot valve 24, a three-way control valve 25, a non-return valve 27′, a secondary three-way manual pilot valve 27, a selector valve 20, a flow amplifier valve 21, and a single acting actuator 22.

In particular, with respect to system 100 of FIG. 2, in system 300: the control solenoid valve 17 is replaced by the three-way control valve 25, the secondary electric switch 18′ is replaced by the three-way manual pilot secondary valve 27, the pressure switch 19 is replaced by the three-way pilot valve 24.

The working fluid line is directly connected to the flow amplifier valve 21 and to the three-way control valve 25. The signal fluid line is directly connected to the pressure reducer 16, to the non-return valve 27′ and to the three-way pilot valve 24. The three-way control valve 25 is connected downstream of the three-way pilot valve 24. Both the secondary three-way manual pilot valve 26 and the three-way control valve 25 are connected to the selector valve 20, which manages the delivery of working fluid to the pilot of the flow amplifier valve 21. The pilot of the three-way pilot valve 24 is also connected downstream of the secondary three-way manual pilot valve 27 and upstream of the selector valve 20. The flow amplifier valve 21 is directly connected to the single-acting actuator 22 and has the function of loading or unloading the actuator 22 according to the pressure signal that reaches the pilot.

### The Operation of the System 300 is Described Below.

Let us consider the three-way manual pilot secondary valve 27 in its de-energized state. In these conditions the three-way pilot valve 24 is de-energized and therefore it allows the passage of the working fluid towards the pilot of the three-way control valve 25. The supply fluid will drive the flow amplifier valve 21, by passing through the three-way control valve 25 and the selector valve 20. The effect of this is the amplified supply of the chamber 23 of the single-acting actuator 22, allowed by the direct connection of the flow amplifier valve 21 with the line of the working fluid. Under these conditions, the valve operates normally, with the chamber 23 pressurized and the valve totally open. This condition is similar to the operation described for the circuit of FIG. 2, in which only the control solenoid valve 17 is energized.

On the other hand, by acting on the three-way manual pilot secondary valve 27 it is possible to carry out the partial stroke phase. In particular: by operating the secondary three-way manual pilot valve 27, the supply fluid will drive the three-way pilot valve 24, which discharges the residual fluid to the pilot of the three-way control valve 25. The three-way control valve 25 is therefore de-energized, thus discharging the residual fluid between the three-way control valve 25 and the pilot of the selector valve 20. Similarly to what was previously described for the system 100 in FIG. 2, the simultaneous effect of the secondary three-way manual pilot valve 26 and of the three-way control valve 25 results in an amplified discharge of the chamber 23 of the single-acting actuator 22. In particular, for different setting values of the pressure reducer 16 it is possible to define different pressures in the chamber 23 of the single-acting actuator 22, therefore a different position of the same actuator 22 and a different degree of opening of the valve on which the single-acting actuator 22 is mounted. The partial stroke value, as well as for the actuation method of FIG. 2, is therefore imposed by the setting on the reducer 16; by subsequently deactivating the secondary three-way manual pilot valve 27, it closes the supply to the selector valve 20 and begins to discharge the residual fluid in the line communicating with the same selector valve 20. The three-way pilot valve 24 changes its state and allows the working fluid to pass again to the pilot of the three-way control valve 25. The supply fluid therefore reaches the selector valve 20 exclusively from the line relating to the three-way control valve 25, so allowing it to flow towards the pilot of the flow amplifier valve 21. The effect of this is the amplified supply of the chamber 23 of the single-acting actuator 22 through the flow amplifier valve 21, hence the complete opening of the valve.

Should one want to switch from a normal or partial stroke to an emergency operating situation, it is necessary to discharge the signal line, for example through a solenoid valve (or similar accessories) placed on the line, upstream of the referenced system. In this way, the three-way pilot valve 24 and the three-way control valve 25 are de-energized. This implies that the pilot of the flow amplifier valve 21 is communicating with the atmosphere. Therefore, as the chamber 23 of the single-acting actuator 22 is now also communicating with the atmosphere, the action of the spring prevails and causes the valve to close. If the signal fluid supply is actuated, by keeping the three-way manual control secondary valve 27 energized, the non-return valve 27′ ensures the correct discharge of the fluid by-passing the pressure reducer.

In addition to the embodiments of the invention, as described before, it should be understood that there are numerous further variants. It must also be understood that said embodiments are only examples and do not limit the aim of the invention, or its applications, or its possible configurations. On the contrary, although the above description makes it possible for the skilled person to implement the present invention at least according to an exemplary configuration thereof, it must be understood that numerous variants of the components described are conceivable, without thereby departing from the aim of the invention, invention, as defined in the appended claims, which are interpreted literally and/or according to their legal equivalents.

1. A control and safety system (200, 300) suitable for conveying circuits of pressurized fluids equipped with at least one process valve, said system comprising:
a pressure reducer (16),
a pilot element (24),
a control valve (25),
a selector valve (20),
a flow amplifier valve (21), e
a single-acting actuator (22), wherein the system (200, 300) comprises a single circuit in which:
a supply line of a working fluid directly connects the pressure reducer (16), to the control valve (25) and to the flow amplifier valve (21),
the control valve (25) is connected to the selector valve (20), which manages the delivery of working fluid to the pilot of the flow amplifier valve (21),
the flow amplifier valve (21) connects the single-acting actuator (22) to the working fluid supply line or to a discharge line and is configured to load or unload the actuator (22) according to the signal pressure that reaches the pilot of the flow amplifier valve (21);
a signal fluid line, directly connected: to the piloting element (24) and to a manual pilot control element (27), or to the pilot element (24) and to the pressure reducer (16) and to a non-return valve {21′); the system (200, 300) being characterized by the fact that:
by operating the manual pilot control element (27), the system is configured to perform a partial stroke operation of the process valve which takes place in times similar to those required by an effective partial stroke operation of the process valve and which involves all the components used in the case of the real partial stroke maneuver, and by the fact that,
by de-energizing both the control valve (25) and the pilot element (24), the system is configured to carry out an emergency operation to close the process valve.

2. The system (200, 300) according to claim 1,
configured so that by energizing the control valve (25), the working fluid drives the flow amplifier valve (21), passing through the selector valve (20), and amplifies the power supply to the chamber (23) of the single-acting actuator (22).

3. The system (200) according to claim 1, further comprising a secondary control valve (26), downstream of the pressure reducer (16) and upstream and in direct connection with the selector valve (20), which is de-energized to carry out the emergency maneuver.

4. The system (200) according to claim 3, configured so that by energizing the secondary control valve (26) the working fluid reaches the selector valve (20) with a pressure equal to the value set by the pressure reducer (16).

5. The system (200, 300) according to claim 1,
configured in such a way that for different setting values of the pressure reducer (16) different pressures are defined in a chamber (23) of the single-acting actuator (22), consequently, a different position of the same actuator (22) and a different degree of opening of the process valve on which the same actuator is mounted.

6. The system (200) according to claim 3, configured so that the pressurization of the line downstream of the secondary control valve (26) and the discharge of the line downstream of the control valve (25) causes a reduction in the pressure of the pilot of the flow amplifier valve (21) and then an amplified discharge of the chamber (23) of the single-acting actuator (22).

7. The system (200) according to claim 3, configured so that by de energizing the secondary control valve (26), the latter closes the supply to the selector valve (20) and discharges the residual fluid in the line communicating with the selector valve (20).

8. The system (200, 300) according to claim 1,
configured in such a way that the pressure drop along the line causes the change of state of the control valve (25).

9. The system (200, 300) according to claim 1, wherein
the manual pilot control element is a manually piloted three-way secondary valve (27), the control valve is a three-way control valve (25) and the pilot element is a three-way pilot valve (24), downstream of which the three-way control valve (25) and the selector valve (20) are connected.

10. The system (200) according to claim 3, wherein the secondary control valve is a three-way secondary control valve (26).

11. The system (200, 300) according to claim 9,
configured so that by deactivating the manually piloted three-way secondary valve (27) the working fluid pilots the three-way pilot valve (24), which discharges the residual fluid to the pilot of the three-way control valve (25), and said three-way control valve (25), resulting in this way de-energized, discharges the residual working fluid between the three-way control valve (25) and the selector valve pilot (20).
